(19) United States
(12) Patent Application Publication
(10) Pub. No.: US 2004/0230143 A1
(43) Pub. Date: Nov. 18, 2004

(54) Climatic enhancer

(76) Inventor: James Mitchell Noel, Tonopah, AZ (US)

Correspondence Address: James Noel, 2049 D Avenue, Linden, IA, 50146, US

(21) Appl. No.: 10/369,387

(22) Filed: May 15, 2003

(51) Int. Cl. A61H 1/00; A61H 23/02

(52) U.S. Cl. 601/70; 601/79

(57) ABSTRACT

The Climatic Enhancer is a sexual/sensual massager. A battery operated controller sends 3.0 volts and low amperage signal to the electric motor/counterweight (see DWG B). This current rotates the counterweight producing a small stimulating vibration. The electric motor/counterweight transfers this vibration into the rubber silicone pad produced from the mold spreader (see DWG C). The mold spreader is sown onto a base cloth (see DWG D) then an upper layer of cloth (per DWG D) is sown over the spreader and base cloth. This allows the user to have a soft and cushioned pad to press against and receive the vibration sensation in their coital area. This product has quick disconnect clips that attach the Climatic Enhancer to allow it to be placed around the wearer's leg (see DWG A).

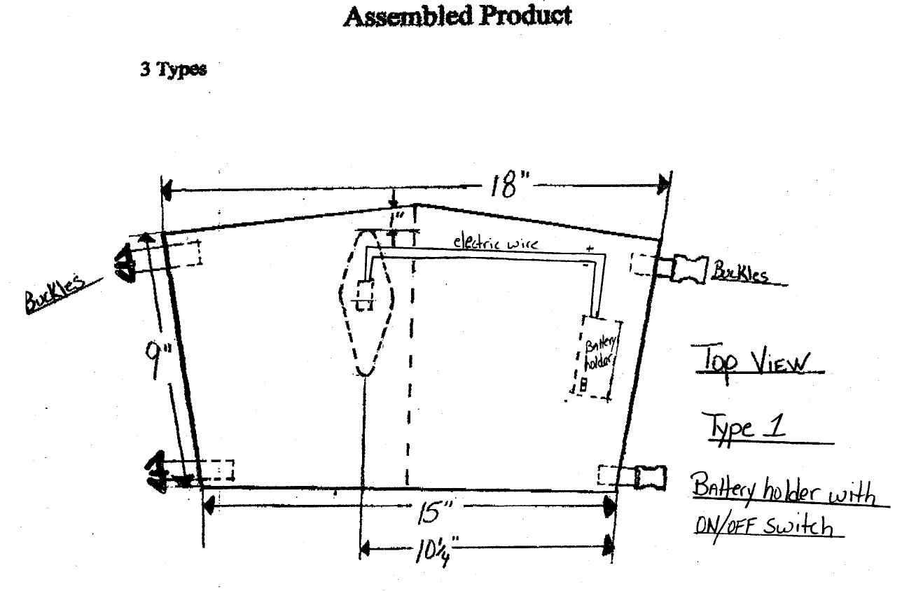

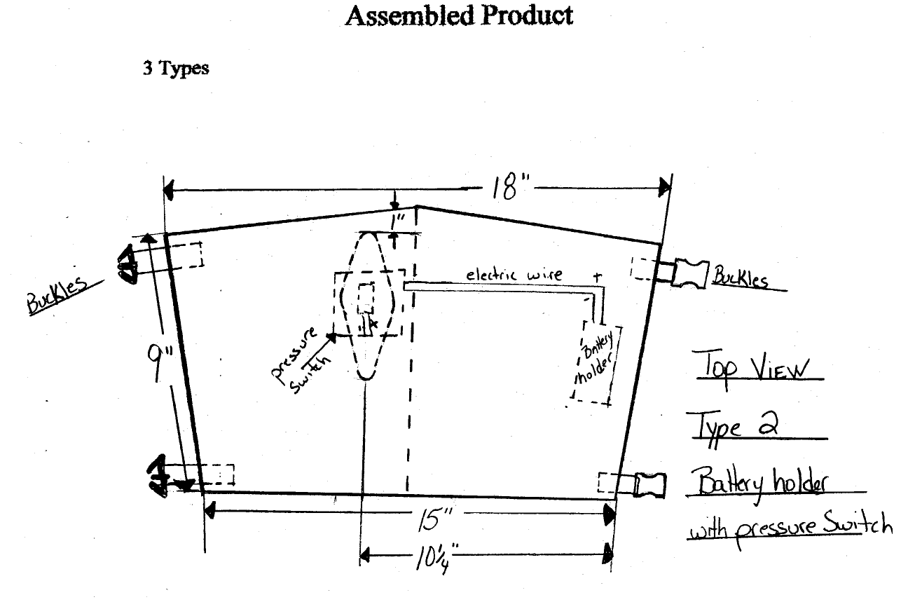

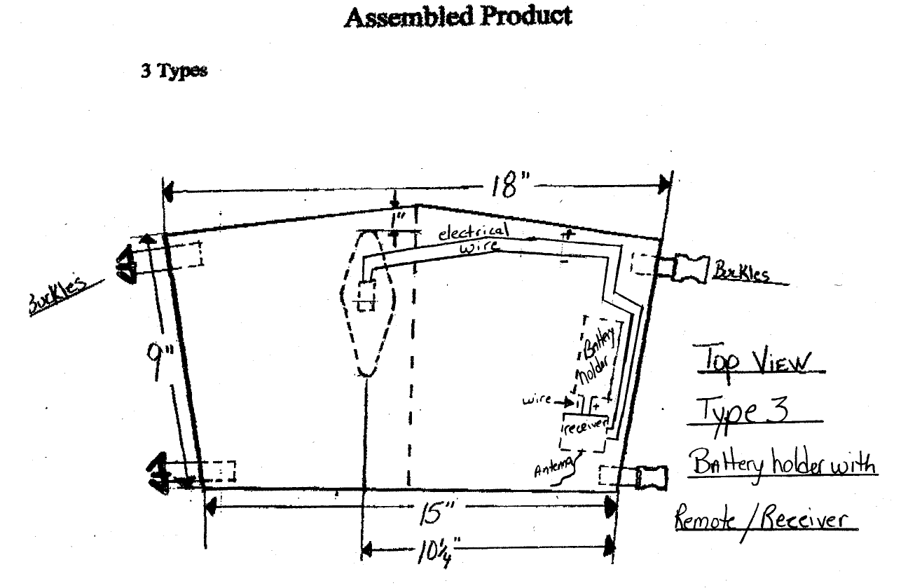

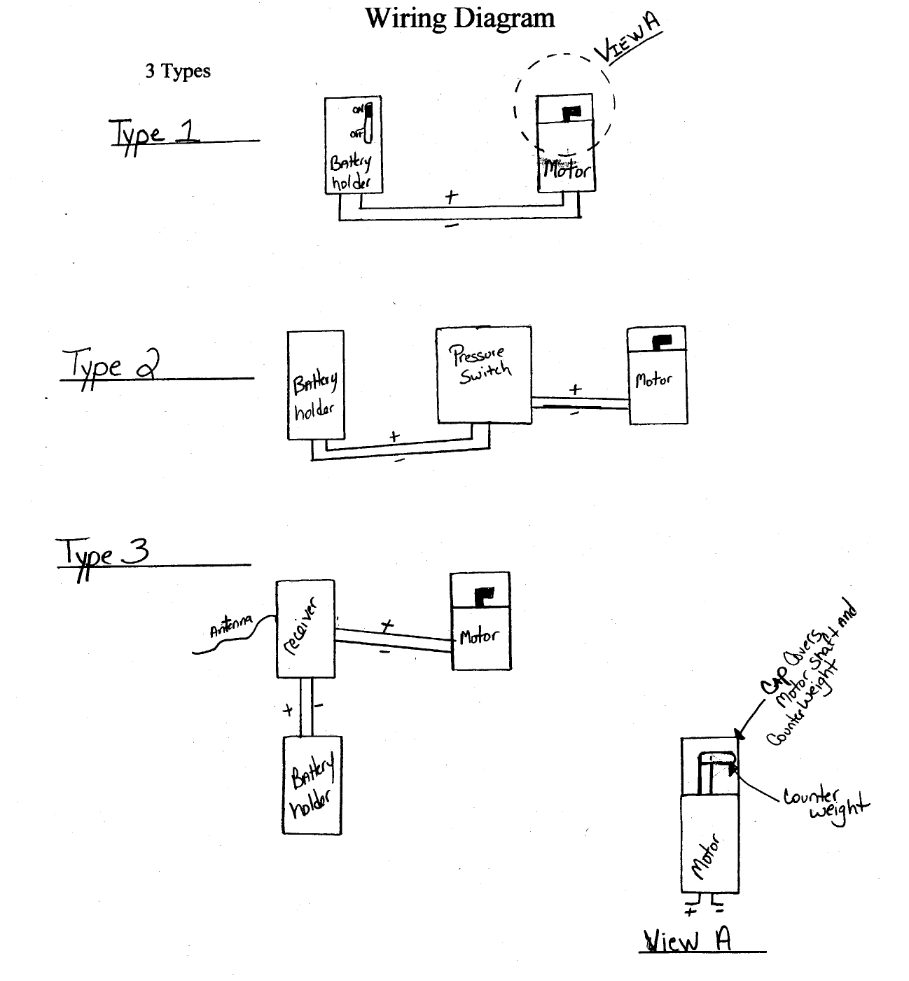

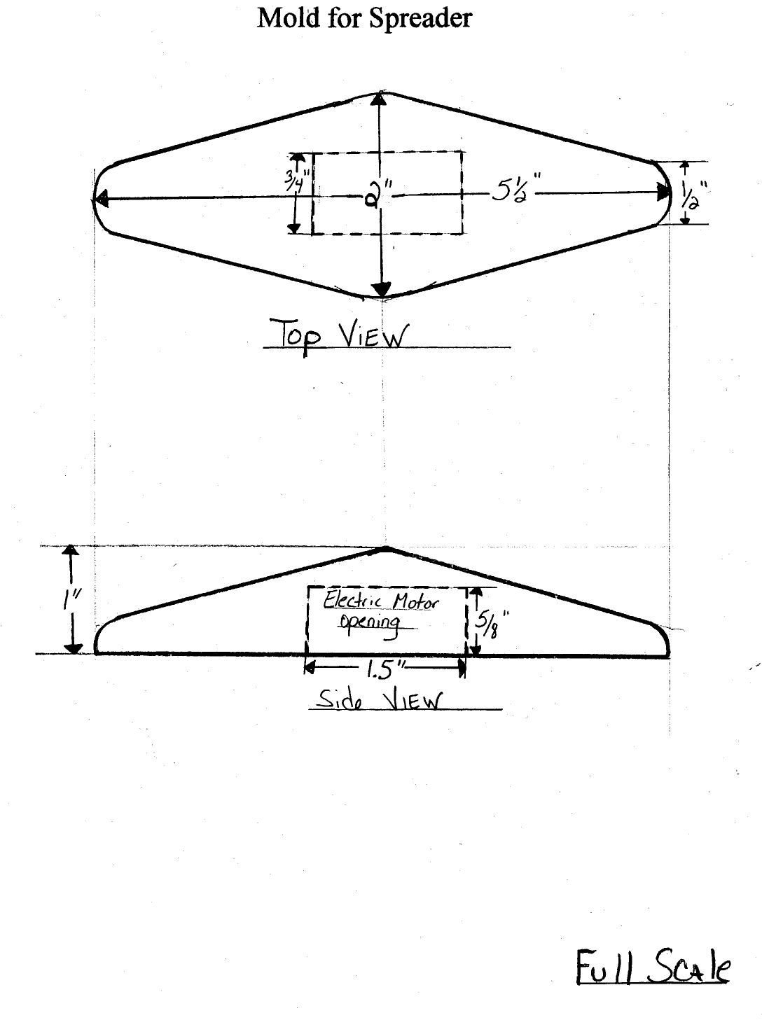

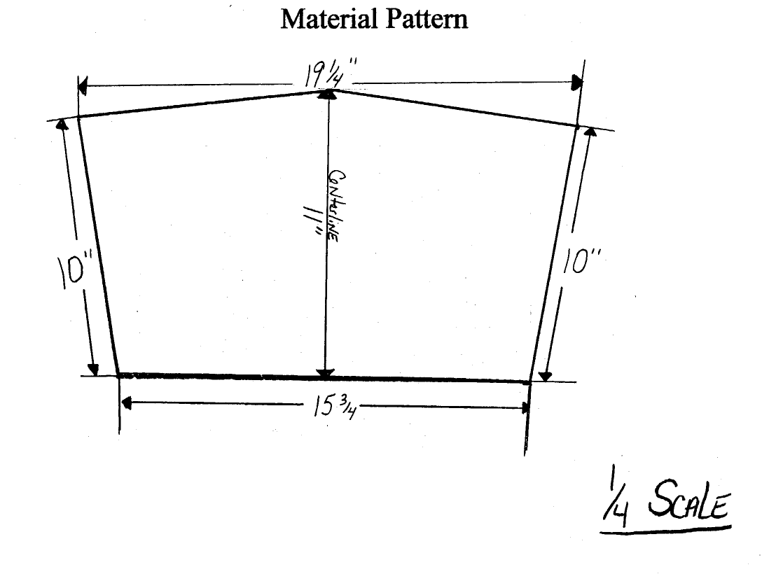

### BACKGROUND OF INVENTION

The Climatic Enhancer is a personal adult-oriented vibration/massager. It's designed to be placed over an individual's leg. The wearer then allows his/her sexual partner to straddle the leg, over the Climatic Enhancer. This provides a place for the partner to experience a vibrating sensation in the coital area.

The Climatic Enhancer is intended for adult use in a sexual/sensual manner.

### Specifications & Assembly Instructions

1) Acquire a list of materials in accordance with Table 1

2) Pour silicone rubber into mold (see drawing C). Compress silicone with upper & lower molds. Let set until cured

3) Assemble motor & electrical components per Drawing B. Note: Decide which type you are building before actual wiring commences.

4) Cut lower base material & an upper for material per drawing D

5) Assemble electrical components, buckles, webbing straps & Velcro in accordance with drawing A (for type you are building).

TABLE 1
Bill of Materials

| | |
|---|---|
| 1) | Electric motor |
| 2) | Wire & solder |
| 3) | Counterweight & cap |
| 4) | Battery holder-see below for types |
| | a. Battery holder with on/off switch (for Type 1) |
| | b. Battery holder with no switch (for Types 2 & 3) |
| | i. Type 2: requires pressure-sensitive switch |
| | ii. Type 3: requires remote & receiver |
| 5) | Rubber silicone |
| 6) | Spreader mold (per Drawing C) |
| 7) | Foam cloth material (for base) |
| 8) | Designer material covering (one-half square yard) |
| 9) | Velcro strip (2″ wide by 2 feet) |
| 10) | Black thread |

Tools needed:
Solder iron
Sewing machine
Tape measure/ruler
Adhesive

1. The Climatic enhancer is a sensual massager worn over the leg of an individual. However the Climatic Enhancer segregates itself from other massagers of medical/sensual nature do to its design. The mold design (see DWG C) that houses the vibrating motor is like no other item anywhere. The assembled product (see DWG A) and the material layout (see DWG D) are also individual from other types of medical/sensual massagers. Then the Climatic Enhancer is assembled per the drawings, these individual items then produce my product which is separate from any other patented product.
